(19) United States
(12) Patent Application Publication
(10) Pub. No.: US 2018/0224936 A1
(43) Pub. Date: Aug. 9, 2018

(54) BRAIN TO BRAIN COMMUNICATION SYSTEM FOR SOCIAL MEDIA

(71) Applicant: David M. Tumey, Coral Springs, FL (US)

(72) Inventor: David M. Tumey, Coral Springs, FL (US)

(21) Appl. No.: 15/890,027

(22) Filed: Feb. 6, 2018

Related U.S. Application Data
(60) Provisional application No. 62/456,279, filed on Feb. 8, 2017.

(51) Int. Cl. G06F 3/01

(52) U.S. Cl. CPC G06F 3/015

(57) ABSTRACT

A brain-to-brain communication system for social media is effected by networking at least two computers with a server by means of a data communication channel, creating a shared virtual/augmented/mixed reality (V/A/MR) environment resident within said server, in which at least two human users can interact by introducing and manipulating communication tokens within said environment utilizing brain-actuated control. Said communication tokens include, for example, symbolic language (symbols), natural language (text), images, movies and other media; facilitating the real-time sharing of thoughts and ideas between said users.

### FIELD OF THE INVENTION

The present invention relates to a brain-to-brain communication system for social media. More particularly, the invention relates to a system for facilitating brain-to-brain communication between at least two human user's utilizing a shared V/A/MR environment in which communication tokens are introduced and manipulated by measuring and analyzing biopotentials (EEG, EOG, and EMG) and providing control signals in response thereto.

### BACKGROUND OF THE INVENTION

### Brief History of Virtual Reality

1950-1970

In the mid 1950s cinematographer Morton Heilig developed the Sensorama (patented 1962) which was an arcade-style theatre cabinet that would stimulate all the senses, not just sight and sound. It featured stereo speakers, a stereoscopic 3D display, fans, smell generators and a vibrating chair. The Sensorama was intended to fully immerse the individual in a cinematic experience. He also created six short films for his invention all of which he filmed, produced and edited himself. The Sensorama films were titled, Motorcycle, Belly Dancer, Dune Buggy, Helicopter, A date with Sabina and I'm a Coca Cola bottle!

Morton Heilig's next commercial offering was the Telesphere Mask (patented 1960) and was the first example of a head-mounted display (HMD), albeit for a non-interactive film medium without any motion tracking. The headset provided stereoscopic 3D and wide vision with stereo sound.

In 1961, two Philco Corporation engineers (Comeau & Bryan) developed the first precursor to the HMD as we know it today—the Headsight. It incorporated an independent video screen for each eye and a magnetic motion tracking system, which was linked to a closed circuit camera. The Headsight was not actually developed for virtual reality applications (the term didn't exist then), but to allow for immersive remote viewing of dangerous situations by the military. Head movements would move a remote camera, allowing the user to naturally look around the environment. Headsight was the first step in the evolution of the VR head mounted display but it lacked the integration of computer and image generation.

In 1965, Ivan Sutherland published a paper describing the “Ultimate Display” concept that could simulate reality to the point where one could not tell the difference from actual reality. His concepts included:
A virtual world viewed through an HMD appearing realistic through augmented 3D sound and tactile feedback.
Computer hardware to create the virtual word and maintain it in real time.
The ability for users to interact with objects in the virtual world in a realistic way.

“The ultimate display would, of course, be a room within which the computer can control the existence of matter. A chair displayed in such a room would be good enough to sit in. Handcuffs displayed in such a room would be confining, and a bullet displayed in such a room would be fatal. With appropriate programming such a display could literally be the Wonderland into which Alice walked”—Ivan Sutherland

This paper would become a core blueprint for the concepts that encompass virtual reality to this day.

In 1968 Ivan Sutherland and his student Bob Sproull created the first VR/AR head mounted display (Sword of Damocles) that was connected to a computer and not a camera. It was a large and cumbersome machine that was too heavy for any user to comfortably wear and was suspended from the ceiling (hence its name). The user would also need to be strapped into the device. The computer generated graphics were very primitive wireframe rooms and objects, but the device clearly demonstrated that creating an artificial or simulated environment was technically feasible.

In 1969 Myron Kruegere a talented computer artist developed a series of experiences for which he coined the phrase “artificial reality”. Kruegere's artificial reality incorporated computer-generated environments that could interact and respond to the people within it. The projects named “GLOWFLOW”, “METAPLAY”, and “PSYCHIC SPACE” were progressions in his research which ultimately led to the development of what he called “VIDEOPLACE” technology. This technology enabled people to communicate with each other in a responsive computer generated environment despite being miles apart.

1970-2000

Even after all these iterative steps in the development of virtual reality, there still wasn't an all-encompassing term to describe the field. This changed in 1987 when Jaron Lanier, founder of the visual programming lab (VPL), coined (or according to some popularized) the term “virtual reality”. The research field now had a lasting name. Through his company VPL, Jaron developed a range of virtual reality gear including the Dataglove (along with Tom Zimmerman) and the EyePhone head mounted display. They were the first company to sell Virtual Reality goggles (EyePhone 1 $9,400; EyePhone HRX $49,000) and gloves ($9000). The glove technology is considered to be a major development in the area of virtual reality haptics—virtual touch/sensation.

By 1991 a number of virtual reality devices began to be commercialized for consumption by the general public, although household ownership of cutting edge virtual reality was still far out of reach. The Virtuality Group launched a range of arcade games and machines. Players would wear a set of VR goggles and play on gaming machines with real-time (less than 50 ms latency) immersive stereoscopic 3D visuals. Some units were also networked together to provide a multi-player gaming experience.

Sega announced the Sega VR headset for the Sega Genesis console at the Consumer Electronics Show in 1993. The wrap-around prototype headset had head position tracking, stereo sound and LCD screens built into the visor. Sega originally intended to commercialize the product at a price point of about $200. However, significant engineering difficulties forced the company to terminate the project in the prototype phase despite Sega having created four games specifically for this product platform. Sega VR ultimately ended in commercial failure.

The Nintendo Virtual Boy (originally known as VR-32) was a 3D gaming console that was intended to be the first portable console that could display true 3D graphics. It was initially released in Japan and North America at a price of $180 (USD) but it was also a commercial failure—despite a number of price reductions. The reported reasons for this failure were a lack of color graphics (games were displayed in red and black); a lack of software support; and, it was difficult to use the console in a comfortable position. The following year commercialization was discontinued.

### 2000-Present

The first fifteen years of the 21st century has seen major, rapid advancement in the development of virtual reality. Computer technology, especially small and powerful mobile technologies, has improved exponentially while prices have declined. The rise of Smartphones with high-density displays and 3D graphics capabilities has enabled the creation of a new generation of lightweight and practical virtual reality devices. The video game industry has continued to drive the development of consumer virtual reality unabated. Depth sensing cameras sensor suites, motion controllers and natural human interfaces are already a part of daily human computing tasks.

Recently companies like Google have released interim virtual reality products such as the Google Cardboard, a DIY headset that uses a Smartphone to drive it. Companies like Samsung have taken this concept further with products such as the Galaxy Gear, which is mass produced and contains “smart” features such as gesture control.

Developer versions of final consumer products have also been available for a few years, so there has been a steady stream of software projects creating content for the imminent market acceptance of modern virtual reality products and applications.

Currently, multiple consumer devices that seem to finally address the unfulfilled promises made by virtual reality in the 1990s will be commercialized in the near future. These include the pioneering Oculus Rift, which was purchased by social media giant Facebook in 2014 for the staggering sum of $2B (USD). An incredible vote of confidence in the direction the VR/AR/MR industry is heading. The Oculus Rift will be competing with products from Valve corporation Magic Leap, HTC, Microsoft as well as Sony Computer Entertainment. These heavyweights are sure to be followed by many other enterprises, should the consumer market grow as expected.

### Prior Use of Brain Actuated Control and Brain-to-Brain Communication

Through the years there has been significant research in the area of detecting and observing various electric potentials generated within the human body for medical diagnosis, biofeedback control of mental and physical states, and control of external devices. In that work, it is well-known to detect on the outer surface of the head electroencephalographic (“EEG”) biopotentials or brainwaves which demonstrate continuous electrical activity in the brain. The intensities of the brain waves or EEG on the surface of the scalp range from zero to 300 microvolts, and their frequencies range from once every few seconds to 50 or more per second. Much of the time, the brain waves are irregular, and no general pattern can be discerned in the EEG. However, at other times distinct patterns are present. For classification purposes, the EEG spectrum has been divided into a number of frequency bands. These frequency bands can be classified into ‘alpha’ (8 Hz to 13 Hz), ‘beta’ (14 Hz to 50 Hz), ‘theta’ (4 Hz to 7 Hz), and delta (below 3.5 Hz). Activities within the various EEG bands have been correlated to states of sleep, relaxation, active thought, etc. Depending on the nature of the activity of interest, it is well-known to detect EEG waves at different areas on the scalp as a function of the part of the brain of interest.

By providing feedback (e.g., visual/audible) with respect to measured EEG biopotentials in a particular EEG band, a subject may be trained to emphasize or de-emphasize an activity associated with that EEG band thereby reinforcing or diminishing the mental and physical state associated therewith. Further, work has been done with a subject to provide a feedback of EEG activity in a particular band, for example, the alpha band of 8 Hz-13 Hz. Using that feedback, the subject learns to control the magnitude of the alpha frequencies to energize a switch or other external device. In other work, through training, a subject is able to generate an alpha biopotential in response to an external stimulus.

A disadvantage in all of the above work is that one measurement site generally produces only one control signal. Using multiple bandpass filters or a Fast Fourier Transform algorithm (FFT), the EEG is divided into a number of frequency sub-spectrums. By employing these techniques, users have been able to work with the time varying EEG spectrum magnitudes. While pure EEG signals may be divided into a number of frequency spectra correlated to mental states, it is very difficult to learn to control those spectra and mental states and to maintain such control over time without extensive practice.

It has been suggested that training time can be reduced in the alpha band by phase matching the biofeedback signal to the bandpassed alpha spectrum signal. This is accomplished by delaying the biofeedback signal by one complete cycle. The delay is set as a function of the predetermined dominant alpha peak frequency of the subject. This approach requires that each subject have a predominant alpha peak frequency that can be measured before training. However, one problem is that not all subjects produce spontaneous alpha. A further disadvantage is that this form of phase loop closure will only work for alpha control because theta and beta dominant peaks are not easily predetermined. It also assumes that the dominant alpha peak frequency of the subject will remain constant over the entire training session.

The time varying characteristics of a bandpass filter output can be used to create an estimate of phase information. Likewise the FFT can provide phase measures as well as magnitude measures. Thus phase information can be used as a feedback signal as well as magnitude. However, other than the attempt to create phase matching to an alpha peak frequency as discussed above, there are no instances in the prior art in which use of phase information is successfully incorporated into a biofeedback paradigm.

The contraction of skeletal muscle is preceded by a sequence of rapid changes in the muscle nerve fiber membrane potential. This sequence of potential changes is called an action potential. Each time an action potential passes along a muscle fiber a small portion of the electrical current spreads away from the muscle as far as the surface of the skin. If many muscle fibers contract simultaneously, the summated electrical potentials at the skin may be great. These summated electrical potentials are referred to as electromyographic biopotentials (EMG).

EMG biopotentials have also been detected and used for various forms of medical diagnosis and biofeedback control. Strong EMG biopotentials are usually considered to occur in a range of approximately 100 Hz-3000 Hz; but since the EMG is the summation of numerous action potentials, EMG biopotentials will occur below 100 Hz as well. Therefore, EMG biopotentials contain frequency components between zero and 100 Hz. EMG biopotentials are typically detected at the site of muscle activity, for example, at the jaw to monitor jaw tension or around the eyes to detect ocular muscle activity. EMG biopotentials may be detected for medical diagnostic purposes in which a patient observes their own muscle tension as a biofeedback signal. In addition, EMG biopotentials may be detected for the purposes of activating a switch mechanism to control an external device. Even though EMG biopotentials are somewhat easier to control because they are produced by a physical activity, any use in the prior art work of EMG signals is in response to an averaged magnitude over a spectrum centered at 100 Hz or more. That averaged magnitude is used to control a single activity or switch. Therefore, a limitation of traditional EMG signal processing is only a single channel of control.

Most of the prior art makes extraordinary efforts to work with signals representing either pure EEG biopotentials or pure EMG biopotentials. In the examples of EEG work, the detection and processing of EEG biopotentials in the range of approximately 0.5 Hz-35 Hz includes processing to reject EEG when it contains artifacts of EMG biopotentials. One approach is to inhibit the production of the feedback signal if an undesirable attribute appears in the EEG biopotentials. Another approach is to obtain a multiplicity of EEG and EMG signals and inhibit feedback when any of the EMG signals exhibit undesirable characteristics. There is a potential problem in using an inhibit approach to deal with an artifact. If a subject simultaneously produces the correct EEG response while producing an inappropriate EMG response, inhibition provides an ambiguous feedback cue. In that case, the absence of feedback due to inhibition suggests to the subject that they are not producing the appropriate EEG response when in fact they are.

Other approaches that attempt to deal with artifacts include: providing subjects with a cross-hair fixation point to limit eye movements, making EEG measurements as far away from potential EMG sources as possible, for example, the occipital and parietal regions of the scalp, and the sensing of and subtraction of the corneoretinal potential from the EEG. All of these approaches have inherent disadvantages. They either provide ambiguous or false feedback cues, require a multiplicity of measurement sites, or they reject the potential usefulness that might be gained by the simultaneous presence of both the EEG and EMG biopotentials. Therefore, even though there has been significant work with EEG and EMG biopotentials for several decades, there have been few practical and/or reliably repeatable results.

In the late 1980's and early 1990's researchers at the Wright Patterson, Air Force Base in Dayton Ohio developed a roll-axis tracking flight simulator that utilized a rudimentary form of brain-actuated control based on Steady-state Evoked Potentials (SSEPs). In this system, a pilot test subject was seated in a simulated cockpit environment mounted on an axle the rotation of which was controlled by an electric motor. A video monitor screen was located directly in front of the pilot that provided an artificial horizon indicating the relative bank angle of the simulator. Flanking the display screen were two small fluorescent lamps the intensity of each being modulated by a sinusoidal frequency generator. The depth of modulation could be varied from between about 20% and 80%. A diffuser screen was placed in front of the fluorescent lamps with a fenestration that permitted viewing of the display screen and artificial horizon. The flight simulator cockpit was also equipped with an EEG amplifier that connected to a lock-in amplifier system implemented using hardware components. The simulator's roll angle was controlled by the output of the lock-in amplifier such that if the output level was below a set threshold (indicating suppression of the SSEP), the simulator would incrementally roll to the left. In the event the lock-in amplifier output was above another set threshold (indicating enhancement of the SSEP), the simulator would incrementally roll to the right. A subject seated in the simulator would be able to manipulate the roll angle of the simulator by varying their individual response to the SSEP stimulus.

In 2015 researchers at the University of Washington created a closed-loop brain-to-brain communications link utilizing SSEPs. In their experiment, a pair of subjects were located in two different laboratories approximately one mile apart. One subject, the “sender”, was connected to an EEG monitoring device while another subject the “recipient” had a Transcranial Magnetic Stimulator (TMS) coil placed over the occipital region of his brain. Two flashing lights of differing frequencies (indicating a “yes” or “no” answer) on either side of a computer screen provided the visual stimulus for the SSEPs. When a “yes” SSEP was produced by the “sender”, a signal was sent via the internet to the TMS coil which subsequently stimulated the recipient's visual cortex producing phosphenes (i.e., flashes of light) subsequently observed by the “recipient”. If a “no” SSEP was produced by the “sender”, no stimulation would be provided to the “recipient” and thus no phosphenes were observed. The “sender” attempted to transmit “yes” and “no” answers to a number of questions provided randomly on the computer screen. In this way, the “recipient” could “guess” how the “sender” answered the question by the observing the presence or absence of phosphenes.

The experiment was carried out in dark rooms and involved five pairs of participants, who played 20 rounds of the question-and-answer game. Each game had eight objects and three questions. The sessions were a random mixture of 10 real games and 10 control games that were structured the same way.

Participants were able to guess the correct object in 72 percent of the real games, compared with just 18 percent of the control rounds. Incorrect guesses in the real games could be caused by several factors, the most likely being uncertainty about whether a phosphene had appeared or not.

While the prior art is replete with examples of the utilization of SSEP in the diagnosis of visual and neurological pathologies and for conducting basic research into the fundamental workings of the brain, there is a dearth of prior art relating to the use of SSEPs in creating a practical functioning brain-to-brain communication interface. In the one example given above, the communications activity was limited to “yes” and “no” answers to predetermined questions and even still had an unacceptably high error rate. While the experiment represented “true” brain-to-brain communication, i.e., the signals from one brain were processed and used to stimulate another, the described prior art system is simply not suitable for use in a practical brain-to-brain communication application. Likewise, there is a dearth of prior art relating to the use of other human biopotentials such as EMG and EOG—for providing a practical brain-to-brain communication interface. Finally, almost all the prior art describes apparatus for use in clinical and laboratory settings using hardware components that would be completely unsuitable for consumer applications such as a portable V/A/MR brain-to-brain communication system.

It is therefore an overriding object of the present invention to improve over the prior art by providing an apparatus and method by which a brain-to-brain communication interface may be practically implemented. It is a further object of the present invention to provide such an apparatus and method that can effect brain-to-brain communication between at least two human users utilizing social media. It is yet another object of the present invention to provide such an apparatus and method that is simple to implement, requiring no bulky electronic systems, sub-systems and components and that can be integrated with existing virtual, augmented and mixed reality display headsets. Finally, it is an object of the present invention to provide such an apparatus and method wherein the user can dramatically increase their gratification and enjoyment of interacting and sharing thoughts and ideas by utilizing a brain-to-brain communication interface to introduce and manipulate communication tokens within an externally shared V/A/MR environment.

### SUMMARY OF THE INVENTION

In accordance with the foregoing objects, the present invention—brain-to-brain communication system for social media—generally comprises networking at least two computers with a server by means of a data communication channel, creating a shared V/A/MR environment resident within said server, in which at least two human users can interact by introducing and manipulating communication tokens within said environment utilizing brain-actuated control. Said communication tokens include, for example, symbolic language (symbols), natural language (text), images, movies and other media; facilitating the real-time sharing of thoughts and ideas between said users. The brain-actuated control, utilized by the present invention comprises releasably attaching a plurality of high-impedance dry Ag/Ag—Cl electrodes to selected locations on a human body part, e.g., scalp; providing a low-noise, high-gain, instrumentation amplifier electrically associated with said plurality of electrodes; utilizing a high-resolution Analog-to-Digital (A/D) converter electrically associated with said instrumentation amplifier and a computer to digitize human biopotential signals (EEG, EOG, EMG) detected by said plurality of electrodes; and, analyzing said digitized human biopotential signals utilizing an algorithm to provide control inputs to said shared V/A/MR environment. The high-impedance electrodes could be incorporated in a stand-alone head band, or could be integrated into a V/A/MR headgear assembly to provide convenience to the user when utilizing the system.

The high-impedance dry Ag/Ag—Cl electrodes of the present invention play an essential role in making the system easy and convenient to use. This type of electrode will be wholly preferred by the user over traditional Ag/Ag—Cl (or Au) electrodes which typically require the use of conductive gels or pastes making them difficult to both apply and remove. In order to realize this important aspect of the invention, the design and construction of the instrumentation amplifier, responsible for faithfully increasing the magnitude of the EEG/EOG/EMG signal potentials received by the electrodes, is critical and must have provisions to reject noise, such as common-mode noise, interfering exogenous electrical noise and most importantly internal noise generated by the active components of the amplifier. For example, the instrumentation amplifier of the present invention should have ultra-low internal noise specifications, e.g., input referred noise≤22 nV/√Hz and input current noise≤0.13 fA/√Hz. The amplifier must also utilize front-end active components with ultra-high input impedance, low current and low capacitance (≥10̂12 Ωinput current≤25 fA, input capacitance≤1.5 pF). Owing to the significant advances made over the past two decades in operational-amplifier design and fabrication there are many suitable off-the-shelf amplifier components that can meet these requirements and that are commercially available and well known to anyone skilled in the relevant arts.

In addition to the stringent requirements for the high impedance Ag/Ag—Cl electrodes and instrumentation amplifier, the present invention will need to make use of a high resolution A/D converter, e.g., >16-bits and preferably 24-bits. The reason for this requirement is twofold. First, the number of bits used to digitally represent the analog signal determines the number of levels to which a signal can be resolved, for example, an A/D converter with 8-bits would be able to resolve an analog signal to 256 levels (2̂8=256) while a 24-bit A/D converter could resolve an analog signal to 16,777,216 levels (2̂24=16,777,216). In this way a higher resolution A/D allows for smaller variations in signal level to be detected and recorded; variations that would otherwise be lost between levels of a low-resolution A/D. Second, since the A/D is able to resolve tiny changes in input signal level, the gain requirement for the instrumentation amplifier is significantly reduced. As amplifier gain is increased there is typically an increase in complexity, noise, power consumption and instability. Therefore, the present invention will make use of one of the myriad high-resolution A/D integrated circuits that are commercially available and well known to anyone skilled in the relevant arts.

Because the present invention is intended to be integrated into an existing, commercially available, V/A/MR headset in at least one embodiment, the electrodes and instrumentation amplifier described herein above will lend themselves well to this configuration, i.e., the components can be fitted inside said headset(s). In addition, since the V/A/MR headsets that are commercially available normally incorporate high-resolution display technology, an externally shared V/A/MR environment utilizing communication tokens, as described above, can readily be implemented.

The amplified and digitized signal potentials obtained from the user's scalp by way of the V/A/MR headset can be further processed by a computer in electrical communication with the A/D. The computer of the present invention can be separate from or, in the alternative, part of the computer used to generate the shared V/A/MR environment. In any case, a lock-in amplifier system or other detection algorithm can be implemented entirely in software and utilized to analyze the digitized EEG/EOG/EMG biopotentials enabling detection and quantization of signals resulting from the user generating explicit control inputs. The output signal(s) from the software-derived lock-in amplifier system, or detection algorithm can subsequently be used within the shared V/A/MR environment for introducing and manipulating communication tokens.

By way of example, a social interaction between multiple human users could be facilitated wherein at least two human users communicate via a shared V/A/MR environment utilizing a symbolic language. Each of said human users can select meaningful symbols (communication tokens) from a library of symbols, for example, and introduce one or more symbols into the shared V/A/MR environment whereupon all other human users who are interacting within the shared environment can see and/or manipulate said symbols. Introduction and manipulation of said symbols of the present invention is facilitated by brain-actuated control. A user could select a desired symbol by moving a mouse pointer (controlled by head movement, for example), over said desired symbol then provide a control signal (by altering their physiological state in a measurable way, for example) causing the desired symbol to be selected and introduced to the shared V/A/MR environment. In this way, the shared environment acts like a “shared external consciousness”. More particularly, a first human user could select a “heart” symbol, for example, implying the message “I love you” and place it into the shared V/A/MR environment while a second human user could move the location of the symbol or alter the symbol in some way (e.g., by adding an “arrow” through the “heart”) within the environment indicating “message received”. Likewise, said second human user could add another “heart” symbol and the symbol “2”, for example, as a response implying “I love you too”. In this example, two individuals are able to instantly communicate their feelings using brain-actuated control of a shared V/A/MR environment in a very intimate fashion. In fact, it is believed that the brain-to-brain communication method of the present invention can provide an interface that is significantly more intimate than any other method with respect to a V/A/MR communications environment.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

FIG. 1 shows a block diagram of an aspect of the present invention—brain-to-brain communication system for social media

FIG. 2 shows in flow diagram a representation of the general processing steps of the present invention.

FIG. 3 shows in exploded view a representation of the head-gear with integrated Ag/Ag—Cl electrodes utilized with the present invention.

FIG. 4 shows in functional block diagram an instrumentation amplifier and filtering system of the present invention.

FIG. 5 shows in functional block diagram a lock-in amplifier system of the present invention.

FIG. 6 shows in flow diagram a representation of the general processing steps of the present invention—brain-to-brain communication system for social media.

### DETAILED DESCRIPTION OF THE PREFERRED EMBODIMENT

Although those of ordinary skill in the art will readily recognize many alternative embodiments, especially in light of the illustrations provided herein, this detailed description is of the preferred embodiment of the present invention, brain-to-brain communication for social media, the scope of which is limited only by the claims appended hereto.

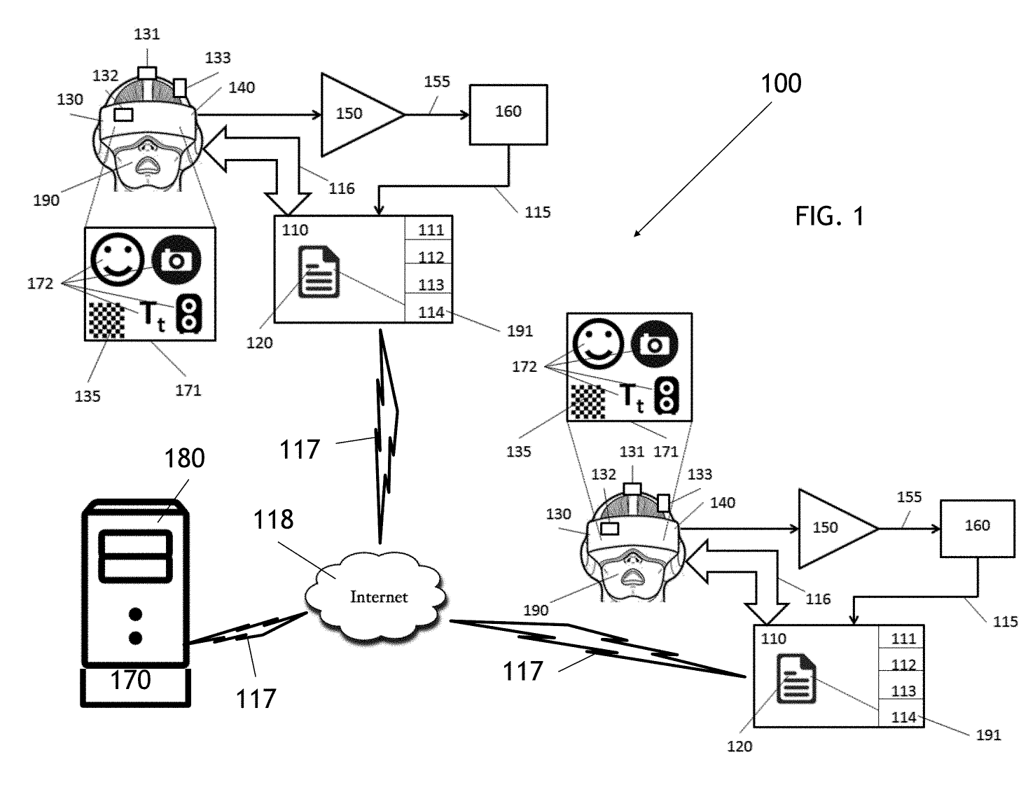

As particularly shown in FIG. 1, a brain-to-brain communication system for social media of the present invention is referred to by the numeral 100, generally comprises a computer-based device 110, software stored within computer-based device for performing the steps of the invention 120, Virtual Reality (VR), Augmented Reality (AR) or Mixed Reality (MR) headgear 130, integrated Ag/Ag—Cl electrode array 140, biopotential amplifier 150, Analog-to-Digital converter 160, data-interchange network connection 117, networked computer server 180 and social media application 170.

Referring now to FIG. 1, a brain-to-brain communication for social media includes a computer 110 well known in the art and commercially available under such trademarks as “IBM®”, “Compaq®”, and “Dell®” having a central processor (CP) 111 which is also well known in the art and commercially available under such trademarks as “Intel® 486”, “Pentium®” and “Motorola 68000”, conventional non-volatile Random Access Memory (RAM) 112, conventional Read Only Memory (ROM) 113, and magnetic disk storage device(s) 114. Computer 110 can be configured as a standard PC, or can be implemented as a custom single-board computer utilizing an embedded operating system such as is sold commercially under the trademark Windows NT®. Likewise, computer 110 could be a smart-phone or derivative thereof well known in the art and commercially available under the trademarks “iPhone®” and “Android®”. Computer 110 is preferably utilized by the present invention in a networked configuration connected to the Internet 118 via a LAN or WiFi or other electronic data-interchange connection 117, for example. For the preferred embodiment of the present invention, a server 180 is networked with at least two computers 110 via Internet 118 and electronic data interchange connections 117. Server 180 has resident therein software requisite for implementing social media application 170. Social media application 170, described in detail herein below, is responsible for rendering at least one shared V/A/MR environment and facilitating communications between at least two human users 190 utilizing communication tokens 172.

Communication tokens 172 can consist of various virtual “objects” that can be introduced and/or manipulated within said shared V/A/MR environment by any of users 190 to effect brain-to-brain communication of the present invention. Introduction and/or manipulation of communication tokens 172 is facilitated by brain-actuated control as described in detail herein below. Communication tokens 172 are intended to convey meaning or intelligence and can either be selected from a library of tokens or created in real-time by a user 190 as part of the function of social media application 170. As described in greater detail below, communication tokens 172 can consist of symbols (e.g., “emojis”), text, pictures (e.g., .jpg, .bmp, .tif, etc.), video clips (e.g., .mov, .avi, .mp4, .m4v, etc.), audio clips (e.g., .wav, .mp3, .wma, etc.), hypertext links (e.g., website), voice-to-voice or any other media that carries some meaning or intelligence intended to be conveyed between at least two human users 190.

Computer 110 is operably associated with communications channel 115 which can be a conventional RS-232, USB, Bluetooth® or another equivalent bi-directional communications port. Communications channel 115 has associated therewith an Analog-to-Digital converter 160 which can be one of myriad devices that are known to anyone of ordinary skill in the art. A/D converter 160 should be of a high-resolution type with not less than 8 bits and preferably 16 to 24 bits. The Analog-to-Digital converter 160 and communications channel 115 are responsible for converting the analog human biopotential signals into a digital representation that can be subsequently processed by computer 110. Computer 110 is further operably associated with disk storage device(s) 114 comprising a file system utilized in storing the software 120, and, optionally, human biopotential data 191. Computer 110 is also electrically associated with a V/A/MR headgear device 130 which is well known in the art and available under the trademark “HoloLens®” for example. Computer 110 connects to the headgear device 130 via a second communications channel 116. This channel provides visual data to headgear device 130 to be viewed by the user. This data can include for example 3D virtual renderings of persons, places, or things and is responsible for the rendering of the shared V/A/MR environment and communication tokens 172 of the present invention. Additionally, communications channel 116 connects various position tracking sensors including a head tracking sensor 131, eye tracking sensor 132 and optionally GPS sensor 133 to computer 110. Headgear device 130 typically has associated with it a high-resolution monitor such as an LCD, LED or other display device, all of which are well known in the art, said monitor designed to present images to a human user 190. Headgear device 130 has a plurality of Ag/Ag—Cl electrodes 140 associated therewith wherein said electrodes 140 are removably associated with said human user 190 the particulars of which are described hereinafter. A biopotential amplifier 150 and an analog communications channel 155 which transmits three analog data types (EEG, EOG and EMG) is electrically associated with the Analog-to-Digital converter 160. Biopotential amplifier 150, communications channel 155 and Analog-to-Digital converter 160 can comprise one or more channel(s). The preferred embodiment of the present invention includes at least one channel. Collectively, these elements (150-160) can be housed within headgear 130 to minimize the bulk and complexity of the system or can be remotely located from headgear 130.

Headgear device 130 also has the capability of projecting one or more visual stimuli 135, if desired, which in the example depicted in FIG. 1 is an alternating checkerboard pattern. Visual stimuli 135 is configured to be a steady-state visual stimuli designed to generate a steady state evoked potential (SSEP) in user 190, detected by electrode array 140 and biopotential amplifier 150. Stimuli 135 may be associated with one or more communication tokens 172 to enable, for example, user 190 to introduce and/or manipulate one or more of said tokens 172 by producing an SSEP in response to said stimuli 135. This is effected by user 190 fixing foveal attention on one or more SSEP tokens 172. In this way, for example, a user 190 could effect brain-to-brain communication by introducing and/or manipulating SSEP tokens 172 within the shared V/A/MR environment of social media application 170. Likewise, a user 190 can introduce and/or manipulate tokens 172 by utilizing any of a number of measureable biopotentials including EEG, EOG and EMG by altering physiological activity, for example. Communication control signals may be derived from myriad human biopotentials 191 and can be utilized by the present invention to effect brain-to-brain communication as described in detail herein below. By way of example with respect to social media application 170, headgear 130 could project a shared V/A/MR environment such as a “living room” and a library of communication tokens 172. A user 190 could communicate with at least one other user 190 by fixing foveal attention on at least one token 172 which has an associated visual steady-state stimulus 135. The token 172 selected by user 190 could subsequently be introduced into the shared V/A/MR environment (e.g., “living room”) to enable interaction with all other users 190. Likewise, a user 190 could generate a physiological signal such as an EMG or EOG biopotential which can be used to select a communication token 172 exactly as described above and introduce token 172 into shared V/A/MR environment. In any case, once a communication token 172 is introduced by a user 190 into shared V/A/MR environment, any other user 190 can either manipulate said token 172 or add a new token 172 by the same means; thus establishing communication between at least two users 190.

It is readily apparent based on the examples described hereinabove, a brain-to-brain communication system for social media 100 depicted in FIG. 1 could effect many forms of brain-to-brain communication including symbolic language, natural language, photographic, and other media (including voice-to-voice communication), without departing from the scope of the present invention.

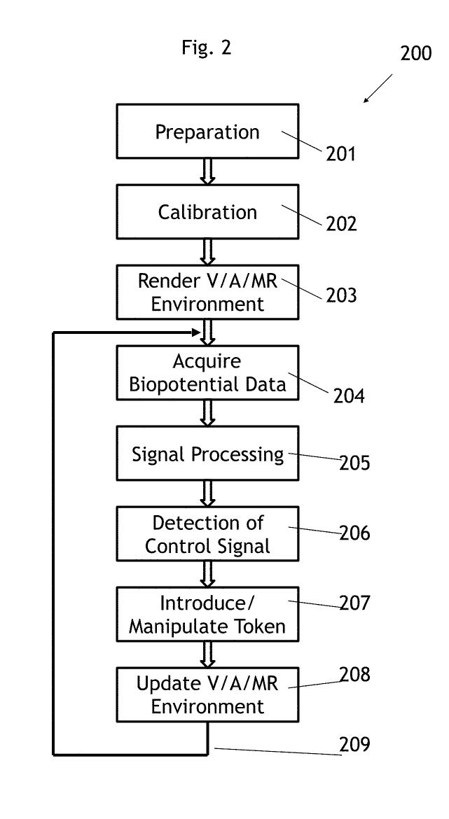

As shown in FIG. 2, the general processing steps 200, appropriate for implementation of the present invention includes preparation step 201, calibration step 202, rendering virtual environment step 203, acquiring biopotential data (EEG, EOG, EMG) step 204, signal processing step 205, detection of control signal step 206, introduce/manipulate communication token step 207, and update virtual environment step 208. It is noted that the steps outlined in FIG. 2 would be required for each human user 190 and in order to effect brain-to-brain communication, the present invention requires at least two human users 190.

Before utilizing the brain actuated control system of the present invention, the user 190 is prepared in step 201. This step consists of cleaning the scalp (forehead, occipital lobe region or other contact regions associated with Ag/Ag—Cl electrodes 140) by gently abrading with an appropriate preparation solution well known to anyone of ordinary skill in the art, cleaning the plurality of electrodes 140 with a mild soap solution or alcohol, placing the headgear 130 on the head of user 190 and connecting the communications cable 116 to computer 110 and electrodes 140 to biopotential amplifier 150. Note that electrodes 140 and communications cable 116, and optionally computer 110 may be integrated into the headgear 130 obviating the need to connect these components prior to use. Likewise, it is possible to apply electrodes 140 to user 190 without cleaning the contact areas of the scalp. These exemplary steps are provided to enable user 190 to optimize the performance of the brain-to-brain communication system.

With the user connected to biopotential amplifier 150, software 120 is started whereupon calibration step 202 is subsequently performed. In this step, the software 120 automatically adjusts the amplifier gains and resting baselines to create an individualized signal envelope for one or more of the three analog biopotential types (EEG, EOG and EMG) transmitted through communications channel 155. This calibration step 202 maximizes the dynamic range of the signal and prevents high-end saturation for large potential swings while ensuring enough gain is applied for the proper amplification of the signal. It should be noted that general processing steps 201 and 202 can be performed by the user 190 alone or with the help of one or more assistants.

With the brain-to-brain communication system 100 now prepared for use, step 203 is performed wherein software associated with the V/A/MR social media application 170 is started. In any event, said software will render a virtual, augmented or mixed reality environment that user 190 can view and interact with via headgear 130. The virtual, augmented or mixed reality environment of social media application 170 may be rendered with very complex features or could be nothing more than a virtual empty space, the only requirement being that at least two human users 190 can interact within said environment by introducing and/or manipulating communication tokens 172 each of which can be viewed by every human user 190. Headgear 130 optionally includes myriad sensors to facilitate this interaction including head position sensor 131, eye position sensor 132 and GPS sensor 133. These sensors can work alone or in conjunction with each other to provide control inputs to computer 110 and enable the user 190 to view and interact with the virtual/augmented/mixed environment, introducing and/or manipulating communication tokens 172.

Next, step 204 acquires biopotential data from user 190 via the electrodes 140, biopotential amplifier 150 and A/D 160. This data can include EEG, EOG and EMG biosignals. The data 191 can further be stored, if needed, within computer 110 as described hereinabove. The biopotential data acquired in step 204 will subsequently be used by software 120 to produce at least one control signal; for example, said control signal can be one of introduction and/or manipulation of at least one communication token 172 within the V/A/MR environment of social media application 170. By way of example, an introduction control signal could select and position a communication token 172 in the shared V/A/MR environment sending a message to at least one other human user 190 while a manipulation control signal could move or alter an existing communication token 172 in the shared V/A/MR environment indicating, for example, that a particular message was understood and acknowledged by at least one other of users 190. As described hereinabove, communication tokens 172 can be selected from a library of tokens or created by each of human users 190.

Signal processing step 205 of the present invention preferably utilizes a lock-in amplifier 500 as a digital signal processing technique the particulars of which are described hereinafter. After the user's 190 biopotential data is acquired it must be processed and analyzed to determine the presence or absence of a control signal. The lock-in amplifier 500 can be implemented as part of software 120 in the form of an algorithm described in greater detail below and is well known to anyone of ordinary skill in the art, and for the preferred embodiment, functions as a very-high Q filter. The lock-in amplifier 500 computes a time-history of the power spectrum for a single predetermined frequency in near real-time. Multiple instantiations of lock-in amplifier 500 can be run concomitantly on computer 110, each with a unique pre-determined frequency and each producing at least one control signal. Since human biopotential signals can be grouped into discrete bands of frequencies, the lock-in amplifier provides a way to discern information about human user's 190 physiological activity at any given point in time. The output signal of processing step 205 is preferably in the form of an analog value the magnitude of which is representative of the strength of the control signal resulting from the user 190 altering his/her physiological activity. This signal is utilized by subsequent steps to determine the presence or absence of one or more control signals and their type.

Processed data from step 205 is utilized by step 206 to make a determination with respect to the presence or absence of a control signal in response to the physiological state of user 190. This step in its simplest form can be configured as a linear threshold detector wherein if the output signal level of lock-in amplifier 500 is greater than a pre-determined threshold value, the presence of a control signal is indicated. Likewise if the output signal level of lock-in amplifier 500 is lower than a pre-determined threshold value, the absence of a control signal is alternately confirmed. The algorithm utilized by step 206 can include non-linear methods, for example basing the decision of presence or absence of a control signal on the square of the output signal from lock-in amplifier 500, or setting multiple thresholds with different activities assigned to each of the ranges between said thresholds. Likewise if the control signal generated in step 205 is analog the magnitude of the signal could be used to modulate some aspect of either introducing and/or manipulating a communication token 172 within the shared V/A/MR environment of social media application 170. Other variables can be taken in consideration by step 206 for example, head position, eye tracking and GPS location could all play a part in the detection process.

When the presence of a communications control signal is detected by step 206, step 207 permits each of at least two users 190 to introduce and/or manipulate at least one communication token 172 within the V/A/MR environment of social media application 170. Step 207 may be implemented in myriad ways, each effective in providing brain-to-brain communication of the present invention, and each within the scope of the present invention. As described in detail hereinabove (FIG. 1), a communication token 172 can consist of a symbol, text, picture (e.g., .jpg, .bmp, .tif, etc.), a video clip (e.g., .mov, .avi, .mp4, .m4v, etc.), audio clip (e.g., .wav, .mp3, .wma, etc.), hypertext link (e.g., website) or any other media that carries some meaning or intelligence intended to be conveyed between at least two human users 190. By way of specific example, a user 190 could introduce into the V/A/MR environment one or more photographs taken from a recent vacation, and a symbol (e.g., an “emoji” “smiley face”)—the message intended to communicate to at least one other user 190 a record of recent activities along with the implied emotion of “happiness”. Likewise said at least one other user 190 could reply by either adding a new communication token 172, as described above, (e.g., an “emoji” “thumbs-up”)—with the implied response “awesome”; or, manipulate an existing communication token 172, such as, moving the photograph token to a virtual pedestal indicating acknowledgment of the message and its importance with respect to the users 190 sharing the V/A/MR environment of social media application 170.

In any case, in step 207, a human user 190 either creates or selects (from a library of tokens, for example) a communication token 172 and introduces the communication token 172 into the shared V/A/MR environment of social media application 170, or manipulates a communication token 172 resident within said shared environment; said manipulation can include moving the token 172 to another location in the environment, removing the token 172 from the environment, or altering some property of token 172 indicating the message intended by communication token 172 has been acknowledged by at least one other human user 190. Finally, step 208 updates the rendering of the V/A/MR environment of social media application 170 to reflect any alterations made by any user 190 in step 207. In this fashion, each user 190 can view the status of the V/A/MR environment in real-time and observe any changes each of which represent the communication of intelligence between at least two users 190. Having completed steps 201-208 of the exemplar method described in detail hereinabove, the social media application 170 will repeat steps 204-208 in a continuous software loop as denoted by the arrow in the flow diagram designated as 209.

While the foregoing steps of FIG. 2 outline an exemplar method to implement the brain-to-brain communication system of the present invention, they are not intended to limit the scope of the present invention. It will be readily apparent to those of ordinary skill in the art that myriad combinations and permutations of the steps detailed hereinabove can be employed in a suitable fashion to substantially derive the same or similar outcomes.

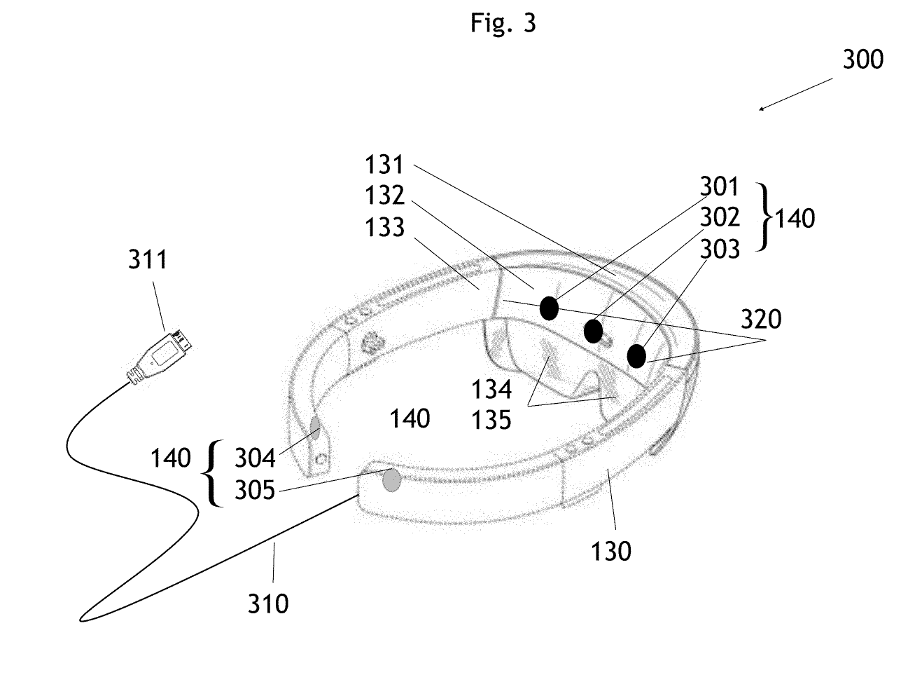

Reference is now made to FIG. 3, an exploded view of a representation 300 of the headgear 130 of the present invention. As can be seen in the drawing, the headgear 130 consists of virtual reality, mixed reality, or augmented reality “goggles” which can be one of many known by those of ordinary skill in the art and commercially available under the trademarks “Oculus Rift®”, “HoloLens®” or “Magic Leap™” for example, and may include a head position sensor 131, eye tracking sensor 132 and GPS locator 133. The headgear 130 may have one of, all of, or none of the foregoing sensors and still be used by the present invention. In addition to the aforementioned sensors, a plurality of electrodes 140 preferably of the Ag/Ag—Cl type are arrayed along the front (301-303) and back (304-305) of headgear 130 in such a way as to permit contact with the scalp of a user 190 when the headgear 130 is placed on the head of said user 190. The present invention could be used with as few as two electrodes but preferably has three or more electrodes in contact with the scalp of user 190. The electrodes 140 can be of any desirable shape or size provided they fit within the confines of the headgear 130. For the present invention, the preferable shape of the electrodes 140 is round and the preferable size range is between 0.250″ and 0.750″. Smaller or larger electrodes are perfectly acceptable as long as they are able to have adequate contact with the user's 190 scalp and provide a usable signal without creating excessive noise.

A flexible cable 310 and multi-contact connector 311 are provided to connect electrodes 140 to biopotential amplifier 150 described in detail hereinabove. The electrodes 140 can be of a permanent or replaceable type enabling the user to renew one or more electrodes that have developed wear, corrosion or another defect making them unsuitable for use with the present invention. The electrodes can be positioned to contact various areas of interest of the scalp as a means to collect aggregate EEG, EOG and EMG data underlying the electrode's position on the scalp. For the present invention, it is preferred to locate electrodes 140 over the frontal (301-303) and occipital (304-305) regions of the brain, the occipital being particularly important when working with SSEPs. The electrodes 140 can be mounted directly to receptacles located on headgear 130, or can be mechanically attached to a separate head-band 320 that is removably attached to headgear 130. A separate headband 320 can be fabricated from a rigid material such as plastic, a semi-rigid material such as rubber or elastic, or a flexible material such as cloth or leather. The principal function of separate headband 320 is to hold the electrodes 140 respectively in stable proximity to each other and to specific locations on the user's scalp while minimizing the potential for artifact caused by movement of the electrodes over the surface of the scalp. The front edge of separate headband 320 is removably affixed to the front central portion, sides and rear portion of headgear 130. In this way, the headband 320 can be removed and periodically washed if needed. For the preferred embodiment of the present invention, the electrodes 140 are fabricated from Ag/Ag—Cl plated carbon-filled plastic. It will be evident to anyone of ordinary skill in the art that myriad other types of electrodes can be satisfactorily utilized by the brain-to-brain communication system 100 including gold/gold-plated electrodes, for example. The front part of electrode array 140 is generally positioned above the Frontal lobe and across the forehead of user 190 with a reference electrode 302 preferably positioned above FPZ, signal electrode 301 preferably positioned above FP1 and signal electrode 303 preferably positioned above FP2 in accordance with the International “10-20” system. The rearward part of electrode array 140 is generally positioned above the Occipital lobe near the back of the head of user 190 with a signal electrode 304 preferably positioned above 01 and a signal electrode 305 positioned above 02 also in accordance with the “10-20” system for electrode placement.

Although there are many combinations and permutations for utilizing the above described electrode arrays 140, in general, electrode 302 which is centrally located within its respective array (301-303) is utilized as the “reference” electrode creating a common-mode rejection configuration to reduce global noise and artifacts. Electrodes 301-303 and 304-305 removably positionable on headgear 130 or separate headband 320 are electrically associated with cable 310 and connector 311. Lead wires attaching to individual electrodes 301-305 are combined to form the cable harness 310 which is preferably shielded to minimize extraneous electrical noise and interference. Cable 310 is preferably removably associated with biopotential amplifier 150 utilizing a common off-the-shelf connector 311 which is readily available and well known to anyone of ordinary skill in the art. Cable 310 is of a suitable length to permit headgear 130 to move freely without interference from any part of the system it is connected to. In this way, the biopotential signals from each of electrodes 301-305 making up electrode array 140 are communicated to biopotential amplifier 150 via cable 310. As further described in detail herein, biopotential amplifier 150 could be integrated directly into headgear 130 or separate headband 320 if so desired to dramatically shorten the length of cable 310 and further reduce the extraneous electrical noise or interference.

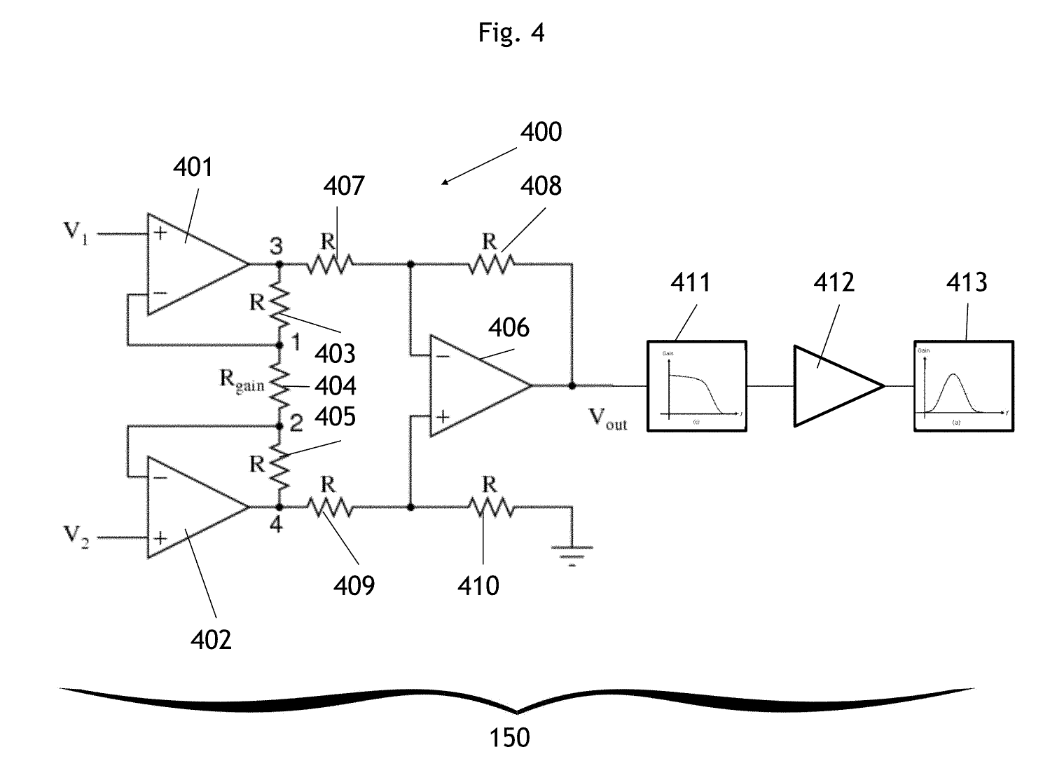

Referring now to FIG. 4, a circuit diagram representation 400 of one or more channels for biopotential amplifier 150 as described in detail hereinabove; it is desired that biopotential amplifier 150 have various characteristics conducive to the use of dry Ag/Ag—Cl electrodes which by necessity will have a very high contact impedance with the human body part, e.g., scalp. To that end, the biopotential amplifier 150 will require ultra-low internal noise specifications, e.g., input referred noise≤22 nV/√Hz and input current noise≤0.13 fA/√Hz. The amplifier must also utilize front-end active components with ultra-high input impedance, low current and low capacitance (≥10̂12Ω, input current≤25 fA, input capacitance≤1.5 pF). In addition, biopotential amplifier 150 must have excellent common-mode noise rejection. Accordingly, biopotential amplifier 150 is preferably configured as an “instrumentation amplifier”. The instrumentation amplifier “front-end” of biopotential amplifier 150 can be constructed from discrete components or can be a single integrated circuit, such as an AD-620 well known to anyone of ordinary skill in the art and commercially available under the trademark “Analog Devices®”, for example. The instrumentation amplifier of the present invention is constructed from a buffered differential amplifier stage 406 with three resistors 403-405 linking the two input buffer circuits 401 and 402 together. If resistors 403, 405 and 407-410 are of equal value, the negative feedback of the upper-left operational amplifier 401 will cause the voltage at point 1 (the junction of resistor 403 and resistor 404) to be equal to the input voltage from one of the signal electrodes 140 (designated V1). Likewise, the negative feedback of the lower-left operational amplifier 402 will cause the voltage at point 2 (the junction of resistor 404 and resistor 405) to be equal to the input voltage from another of the signal electrodes 140 (designated V2). This establishes a voltage drop across resistor 404 equal to the voltage difference between V1 and V2. That voltage drop causes a current through resistor 404 and since the feedback loops of the two input operational amplifiers 401 and 402 draw no current, that same amount of current through resistor 404 must be flowing through the resistor 403 and resistor 405 above and below it. This produces a voltage drop between points 3 and 4 equal to:

$${V}_{3 \text{-} 4} = ( {V}_{2} - {V}_{1} ) ( 1 + \frac{2 R}{{R}_{gain}} )$$

Operational-amplifier 406 configured as a standard differential amplifier on the right-middle of the circuit then takes this voltage drop between points 3 and 4 and amplifies it by a pre-determined gain factor. This instrumentation amplifier configuration has the distinct advantage of possessing extremely high input impedances on the V1 and V2 inputs (because they connect directly to the non-inverting inputs of their respective operational-amplifiers 401 and 402), and adjustable gain that can be selected by adjusting the value of a single resistor 404. Making use of the formula provided above, a general expression for overall voltage gain of the instrumentation amplifier is:

$${A}_{V} = ( 1 + \frac{2 R}{{R}_{gain}} )$$

It becomes apparent by viewing the schematic of FIG. 4. that the gain of the instrumentation amplifier could also be changed by changing the values of some of the other resistors. This, of course, would necessitate balanced resistor value changes in order for the circuit to remain symmetrical. Thus the gain of the amplifier is typically set by selecting a specific value for resistor 404 only. With respect to the present invention, a preferred value range of the gain of instrumentation amplifier 400 is between 10 and 40. Since the electrodes 140 are metalized and in contact with living tissue containing electrolytes, it is possible for the interaction to produce small voltages that will drive the operational amplifiers 401, 402 and 406 into saturation if the overall gain is set too high. In the present invention, the remaining stages of biopotential amplifier 150 are A.C. coupled to the instrumentation amplifier to prevent any D.C. offset voltages to be presented to succeeding stages. Since the biopotentials being amplified by biopotential amplifier 150 are in the order of 10̂−6 to 10̂−3 volts, additional gain and filtering stages are needed to produce a signal usable by the present invention. To that end, three exemplar follow-on stages are shown in FIG. 4. These stages include: low-pass filter 411, amplifier gain-stage 412 and band-pass filter 413. Low-pass filter 411 can be passive or active and is well known to anyone of ordinary skill in the art. Preferably a two-pole “Sallen-Key” type active filter using a single operational-amplifier would be used in the present invention as low-pass filter 411. Amplifier gain-stage 412 could be configured as one or more inverting or non-inverting operational-amplifiers each having a gain in the range of 10 to 100. For the present invention, the gain of amplifier 412 is preferably ˜50. Finally, a band-pass filter 413 can be employed and can be of many configurations well known in the art including a “Butterworth” filter, “Chebyshev” filter, or an “Infinite Gain Multiple Feedback” (IGMF) filter. The band-pass filter 413 can be configured to have any desired gain, or can be a unity-gain filter. Likewise, additional filtering or gain stages can be added sequentially to the signal chain of biopotential amplifier 150 the objective being to produce a conditioned signal suitable for use in effecting brain actuated control of the present invention.

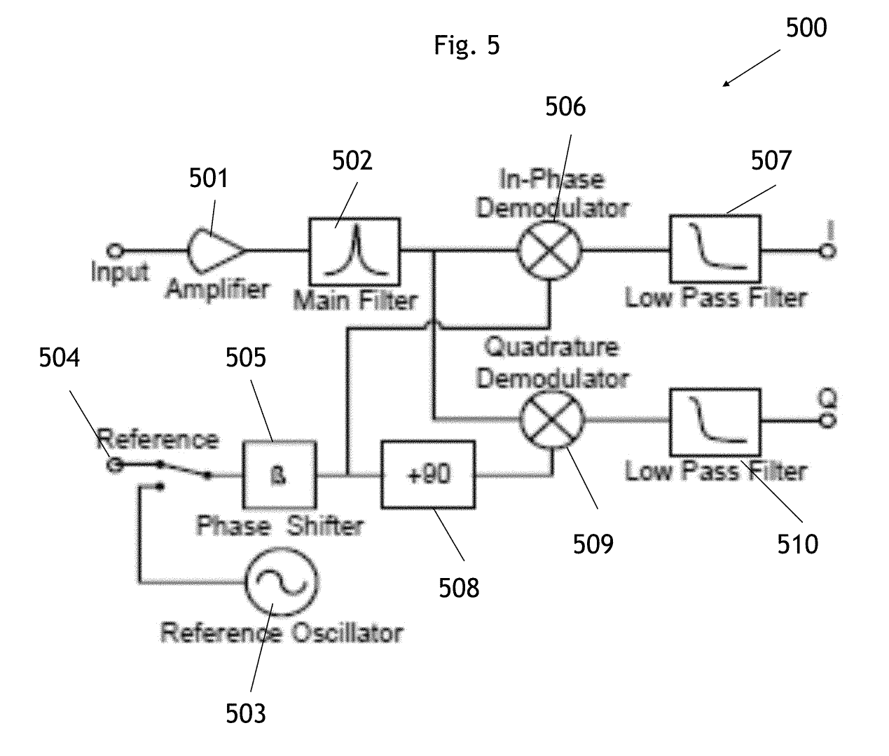

FIG. 5 depicts a block-diagram representation of a conventional “lock-in” amplifier 500 of the present invention. Lock-in amplifier 500 can be implemented utilizing hard-wired electronic components (hardware) or entirely as a software algorithm. The preferred embodiment of the present invention utilizes a software-derived lock-in amplifier system 500 to reduce parts count and associated cost; facilitate real-time changes to amplifier parameters; and, permit the creation of multiple instantiations of lock-in amplifier 500 at different frequencies without incurring additional cost. The lock-in amplifier system consists of an input amplifier stage 501 that increases the magnitude of the signal to a suitable level for further manipulation if necessary. Likewise, amplifier stage 501 could perform an impedance conversion in the process as well. In a hardware implementation, amplifier 501 could be a transistor circuit or operational-amplifier or the like; for a software implementation, amplifier 501 can be modeled by multiplying the discrete input signal by a constant gain factor “G”. A band-pass filter 502 can be employed to remove any signal components that are either at the D.C. level or at harmonics of the signal to be measured to help prevent aliasing. In a hardware implementation, band-pass filter 502 can be one of many well known to anyone of ordinary skill in the art and described in detail hereinabove; for a software implementation, band-pass filter 502 could be, for example, a software-derived Finite Impulse Response (FIR) filter or Infinite Impulse Response (IIR) filter, for example.

The next stage of lock-in amplifier 500 is the in-phase demodulator 506 also known as a synchronous demodulator or simply “mixer”. This system element can take many forms, from a logarithmic amplifier to dedicated four-quadrant multiplier. In any case with either a hardware or software implementation, the processed input signal is multiplied by a reference signal from a sinusoidal oscillator 503 or an optional external reference 504 and a phase-shift element 505. Since the reference signal must maintain a fixed-phase relationship to the input signal, it can optionally be locked to the reference signal using a Phase-Locked Loop (PLL) (not shown). A quadrature demodulator 509 is also provided which mixes the processed input signal with a 90 degree phase-shifted version of the reference 508. This addition has the useful property that it is then quite simple to directly calculate the magnitude of the input signal and its phase relationship to the reference signal. These two separate “channels” are normally referred to as the “I” component and the “Q” component respectively. There are myriad electronic hardware components available and well known to anyone of ordinary skill in the art to implement the in-phase demodulator 506, quadrature demodulator 509 and 90 degree phase-shift element 508 of the present invention; for software, both demodulators and phase-shift element 508 can be implemented using simple trigonometric functions.

Finally, the output from the in-phase demodulator 506 and quadrature demodulator 509 are fed into low-pass filters 507 and 510 respectively which effectively removes any non-coherent signals leaving a D.C. signal that is proportional to the amplitude and phase of the original input signal with respect to the reference signal. Since the present invention is primarily concerned with the presence and magnitude of a targeted band of biopotential signal frequencies, the power spectrum for the input signal with respect to the reference signal can be derived as follows:

Mₚₛ=√(I²+Q²)

This signal can be utilized by processing step 205 of the present invention described in detail hereinabove (FIG. 2) to make a determination with respect to the presence or absence of a specific target biopotential signal.

As described above, the present invention can utilize either a hardware or software implementation of the lock-in amplifier system 500 but for the reasons given, a software implementation is preferred. There are a number of problems with analog lock-in amplifiers. For the highest accuracy, the reference signal must have a very low harmonic content. In other words, it must be a very pure sine wave since any additional harmonic content will likely cause distortion at the output. Analog sine wave generators can also suffer from frequency, amplitude and phase variations that would also introduce potentially distorting artifacts. On the other hand, a sine wave generator can be implemented in software simply by using a Sine or Cosine trigonometric function. Since the signal generated by said function is ideal, there can be no variation of frequency, amplitude or phase.

It is clear from the foregoing description that many variations, combinations and permutations of the various hardware and software elements described in FIG. 5. as part of lock-in amplifier system 500 could be employed in a suitable fashion to substantially derive the same or similar outputs. Therefore, the arrangement given is an exemplar method to implement a lock-in amplifier 500 of the brain actuated control system of the present invention and is not intended to limit the scope of the present invention. In addition, to implement certain aspects of the present invention, such as, for example, introducing or manipulating one or more communication tokens into the V/A/MR environment, a simple hardware or software filtering system (e.g., multi-pole bandpass filter) could be employed with an envelope detector coupled to a threshold detector. If the predetermined threshold is exceeded a signal indicative of either introduction and/or manipulation of a communication token 172 could be produced. Likewise if the threshold is not exceeded no communication signal would be produced, for example. This and myriad other signal analysis techniques, well known to anyone of ordinary skill in the relevant arts could be employed without departing from the scope of the present invention.

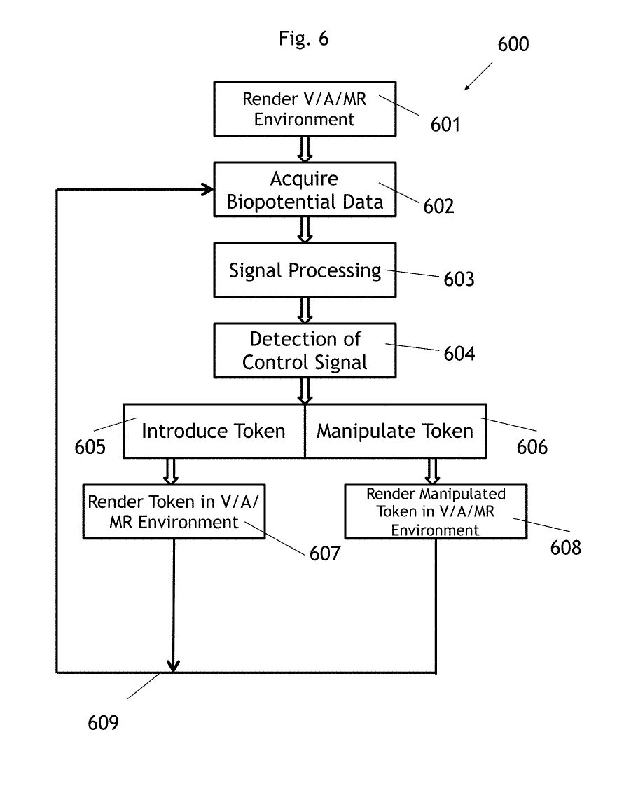

As shown particularly in FIG. 6, a flow diagram representation of the general processing steps 600 of the present invention for brain-to-brain communication includes: render V/A/MR environment step 601, acquire biopotential data step 602, signal processing step 603, detection of control signal 604, introduce communication token step 605, manipulate communication token step 606, render communication token in V/A/MR environment step 607, render manipulated token in V/A/MR environment step 608.

With the brain-to-brain communication system for social media 100 prepared for use as described in further detail hereinabove (FIG. 2), step 601 is performed wherein software associated with a social media application 170 is started. The social media application 170 software will render a shared V/A/MR environment that at least two users 190 can view and interact with via headgear 130. Also as described above, headgear 130 optionally includes myriad sensors to facilitate this interaction including head position sensor 131, eye position sensor 132 and GPS sensor 133. These sensors can work alone or in conjunction with each other to provide control inputs to computer 110 and enable the user 130 to view and interact with the V/A/MR environment in a natural way. It is anticipated that social media application 170 shall preferably be operating within or communicating with a server 180 that is distal from one or more users 190. Accordingly it is within the scope of the present invention to render a shared V/A/MR environment with multiple users 190, each of whom would view the shared V/A/MR environment from a first-person perspective and could further view other human users 190, also within the shared environment, as a representative avatar. Thus, for example, it will be possible for associates, colleagues, friends or family members to communicate with each other by interacting within the shared V/A/MR environment. In any event, step 601 is responsible for rendering this shared V/A/MR environment in all its complexity and detail.

Subsequent the rendering of the shared V/A/MR environment in step 601, step 602 acquires biopotential data 191 from user 190 via the electrodes 140, biopotential amplifier 150 and A/D 160. This data can include EEG, EOG and EMG biosignals. The data can further be stored, if needed, within computer 110 as described hereinabove (FIG. 1). The biopotential data 191 acquired in step 602 will subsequently be used by software 120 to produce at least one control signal; for example, said control signal can be one of introduction and/or manipulation of at least one communication token 172 within the shared V/A/MR environment of social media application 170. By way of example, an introduction control signal could select and position a communication token 172 in the shared V/A/MR environment sending a message to at least one other human user 190 while a manipulation control signal could move or alter an existing communication token 172 in the shared V/A/MR environment indicating, for example, that a particular message was understood and acknowledged by at least one other of users 190. As described hereinabove, communication tokens 172 can be selected from a library of tokens or created by each of human users 190.

Signal processing step 603 of the present invention preferably utilizes a lock-in amplifier 500 as a digital signal processing technique the particulars of which are described hereinabove. After the user's 190 biopotential data 191 is acquired it must be processed and analyzed to determine the presence or absence of a control signal. The lock-in amplifier 500 can be implemented as part of software 120 in the form of an algorithm described in greater detail above (FIG. 5) and is well known to anyone of ordinary skill in the art, and for the preferred embodiment, functions as a very-high Q filter. The lock-in amplifier 500 computes a time-history of the power spectrum for a single predetermined frequency in near real-time. Multiple instantiations of lock-in amplifier 500 can be run concomitantly on computer 110, each with a unique pre-determined frequency and each producing at least one control signal. Since human biopotential signals can be grouped into discrete bands of frequencies, the lock-in amplifier provides a way to discern information about human user's 190 physiological activity at any given point in time. The output signal of processing step 603 is preferably in the form of an analog value the magnitude of which is representative of the strength of the control signal resulting from the user 190 altering his/her physiological activity. This signal is utilized by subsequent steps to determine the presence or absence of one or more control signals and their type.

Processed data from step 603 is utilized by step 604 to make a determination with respect to the presence or absence of a control signal in response to the physiological state of user 190. This step in its simplest form can be configured as a linear threshold detector wherein if the output signal level of lock-in amplifier 500 is greater than a pre-determined threshold value, the presence of a control signal is indicated. Likewise if the output signal level of lock-in amplifier 500 is lower than a pre-determined threshold value, the absence of a control signal is alternately confirmed. The algorithm utilized by step 604 can include non-linear methods, for example basing the decision of presence or absence of a control signal on the square of the output signal from lock-in amplifier 500, or setting multiple thresholds with different activities assigned to each of the ranges between said thresholds. Likewise if the control signal generated in step 603 is analog the magnitude of the signal could be used to modulate some aspect of either introducing and/or manipulating a communication token 172 within the shared V/A/MR environment of social media application 170. Other variables can be taken in consideration by step 604 for example, head position, eye tracking and GPS location could all play a part in the detection process.

When the presence of a communications control signal is detected by step 604, step 605 and step 606 permits a user 190 to introduce and/or manipulate at least one communication token 172 within the V/A/MR environment of social media application 170 respectively. Steps 605 and 606 may be implemented in myriad ways, each effective in providing brain-to-brain communication of the present invention, and each within the scope of the present invention. As described in detail hereinabove (FIG. 1), a communication token 172 can consist of a symbol, text, picture (e.g., .jpg, .bmp, .tif, etc.), a video clip (e.g., .mov, .avi, .mp4, .m4v, etc.), audio clip (e.g., .wav, .mp3, .wma, etc.), hypertext link (e.g., website) or any other media that carries some meaning or intelligence intended to be conveyed between at least two human users 190. By way of specific example, a user 190 could introduce (step 605) into the V/A/MR environment one or more photographs taken from a recent vacation, and a symbol (e.g., an “emoji” “smiley face”)—the message intended to communicate to at least one other user 190 a record of recent activities along with the implied emotion of “happiness”. Likewise said at least one other user 190 could reply by either introducing (step 605) a new communication token 172, as described above, (e.g., an “emoji” “thumbs-up”)—with the implied response “awesome”; or, manipulate (step 606) an existing communication token 172, such as, moving the photograph communication token to a virtual pedestal indicating acknowledgment of the message and its importance with respect to the users 190 sharing the V/A/MR environment of social media application 170.

In any case, in step 605, a human user 190 either creates or selects (from a library of tokens, for example) a communication token 172 and introduces the communication token 172 into the shared V/A/MR environment of social media application 170, or in step 606 manipulates a communication token 172 resident within said shared environment; said manipulation can include moving the token 172 to another location in the environment, removing the token 172 from the environment, or altering some property of token 172 indicating the message intended by communication token 172 has been acknowledged by at least one other human user 190.

Finally, step 607 or step 608 updates the rendering of the V/A/MR environment of social media application 170 to reflect any alterations made by any user 190 in steps 605 or 606 respectively. In this fashion, each user 190 can view the status of the V/A/MR environment in real-time and observe any changes each of which represent the communication of intelligence between at least two users 190. Having completed steps 601-608 of the exemplar method described in detail herein, the social media application 170 will repeat steps 602-608 in a continuous software loop as denoted by the arrow in the flow diagram designated as 609. Software loop 609 is operable until discontinued by social media application 170.

The above described embodiments are set forth by way of example and are not for the purpose of limiting the scope of the present invention. It will be readily apparent that obvious modifications, derivations and variations can be made to the embodiments without departing from the scope of the invention. For example, the signal processing algorithm described in detail above as utilizing lock-in amplifier 500 could be one of many other algorithms well known to anyone of ordinary skill in the art. Likewise myriad signal processing techniques are known which could provide output signals substantially equivalent to those utilized by the present invention for example Discrete Fourier Transforms (DFTs), Phase Space Reconstruction, Hidden Markov Models, and Wavelet Analysis. Accordingly, the claims appended hereto should be read in their full scope including any such modifications, derivations and variations.

What is claimed is:

1. An apparatus for facilitating brain-to-brain communication between at least two human users utilizing human biopotential signals produced by physiological activity of each user, the apparatus comprising:
a computer server connected to the Internet by means of a data communications channel;
at least two computers connected to said server by means of a data communications channel;
a software social media application resident on said server and shared by said at least two computers;
a head-mounted device adapted to each human user to enable viewing and interacting with said shared software social media application;
a sensor adapted to be applied to a body part of each human user for producing an input signal representing an aggregate of human biopotentials, said input signal changing in response to physiological activity of each user;
an amplifier and analog-to-digital converter adapted to digitize said human biopotentials;
a signal processing algorithm responsive to said digitized signal and for generating at least one control signal, said control signal being associated with changes in said physiological activity of a user; and
a software algorithm responsive to said control signal for introducing and manipulating at least one communication token of said social media application as a function of the changes in said control signal.

2. The brain-to-brain communication apparatus of claim 1 wherein the software social media application is a three-dimensional (3D) virtual reality application.

3. The brain-to-brain communication apparatus of claim 1 wherein the software social media application is a three-dimensional (3D) augmented reality application.

4. The brain-to-brain communication apparatus of claim 1 wherein the software social media application is a three-dimensional (3D) mixed reality application.

5. The brain-to-brain communication apparatus of claim 2 wherein a first user can select and introduce a symbolic communication token within said virtual reality application.

6. The brain-to-brain communications apparatus of claim 5 wherein a second user can manipulate said symbolic communication token within said virtual reality application.

7. The brain-to-brain communication apparatus of claim 3 wherein a first user can select and introduce a symbolic communication token within said augmented reality application.

8. The brain-to-brain communications apparatus of claim 7 wherein a second user can manipulate said symbolic communication token within said augmented reality application.

9. The brain-to-brain communication apparatus of claim 4 wherein a first user can select and introduce a symbolic communication token within said mixed reality application.

10. The brain-to-brain communications apparatus of claim 9 wherein a second user can manipulate said symbolic communication token within said mixed reality application.

11. The brain-to-brain communication apparatus of claim 2 wherein a second user can select and introduce a symbolic communication token within said virtual reality application.

12. The brain-to-brain communication apparatus of claim 3 wherein a second user can select and introduce a symbolic communication token within said augmented reality application.

13. The brain-to-brain communication apparatus of claim 4 wherein a second user can select and introduce a symbolic communication token within said mixed reality application.

14. A method for facilitating brain-to-brain communication between at least two human users utilizing human biopotential signals produced by physiological activity of each user, the method comprising:
establishing a computer server connected to the Internet by means of a data communication channel;
connecting at least two computers to said server by means of a data communication channel;
instituting a shared software social media application resident within said server wherein said at least two human users may interact;
acquiring said human biopotential signals and generating at least one control signal utilizing a signal processing algorithm; said control signal being associated with changes in said physiological activity of a user; and
providing communications between said at least two human users by introducing and manipulating communication tokens within said shared software social media application in response to said control signal.

15. The brain-to-brain communication method of claim 14, wherein the software social media application is a three-dimensional (3D) virtual reality application.

16. The brain-to-brain communication method of claim 14, wherein the software social media application is a three-dimensional (3D) augmented reality application.

17. The brain-to-brain communication method of claim 14, wherein the software social media application is a three-dimensional (3D) mixed reality application.

18. The brain-to-brain communication method of claim 15 wherein a first user can select and introduce a symbolic communication token in said virtual reality application.

19. The brain-to-brain communications method of claim 18 wherein a second user can manipulate said symbolic communication token within said virtual reality application.

20. The brain-to-brain communication method of claim 16 wherein a first user can select and introduce a symbolic communication token in said augmented reality application.

21. The brain-to-brain communications method of claim 20 wherein a second user can manipulate said symbolic communication token within said augmented reality application.

22. The brain-to-brain communication method of claim 17 wherein a first user can select and introduce a symbolic communication token in said mixed reality application.

23. The brain-to-brain communications method of claim 22 wherein a second user can manipulate said symbolic communication token within said augmented reality application.

24. The brain-to-brain communication method of claim 15 wherein a second user can select and introduce a symbolic communication token within said virtual reality application.

25. The brain-to-brain communication method of claim 16 wherein a second user can select and introduce a symbolic communication token within said augmented reality application.

26. The brain-to-brain communication method of claim 17 wherein a second user can select and introduce a symbolic communication token within said mixed reality application.
